(19) United States
(12) Patent Application Publication
(10) Pub. No.: US 2011/0300977 A1
(43) Pub. Date: Dec. 8, 2011

(54) SPROCKET

(75) Inventors: Atsushi Hayami, Osaka (JP); Kaori Mori, Osaka (JP); Masahiko Konno, Osaka (JP); Yuji Kurematsu, Osaka (JP)

(73) Assignee: TSUBAKIMOTO CHAIN CO.,, Osaka (JP)

(21) Appl. No.: 13/116,202

(22) Filed: May 26, 2011

(30) Foreign Application Priority Data
Jun. 4, 2010 (JP) 2010-129338

(51) Int. Cl. F16H 55/14

(52) U.S. Cl. 474/161

(57) ABSTRACT

In a sprocket comprising a sprocket hub, sprocket teeth and a cushion plate for contacting link plates of a transmission chain, the cushion plate is formed with concave portions at angular positions corresponding to the angular positions of the tips of the sprocket teeth, thereby avoiding contact, or reducing contact pressure, between the cushion plate and the middle parts of link plates of the chain.

### CROSS REFERENCE TO RELATED APPLICATIONS

This application claims priority on the basis of Japanese Patent Application 2010-129338, filed on Jun. 4, 2010. The disclosure of Japanese Patent Application 2010-129338 is incorporated by reference.

### FIELD OF THE INVENTION

This invention relates to a sprocket having teeth formed on the peripheral surface of a sprocket hub for engagement with pins, bushings or rollers of a transmission chain, and cushion rings formed on the sides of the sprocket hub and having outer peripheral surfaces for contact with link plates of the transmission chain.

### BACKGROUND OF THE INVENTION

In a chain transmission mechanism comprising a transmission chain in mesh with a driving sprocket and with one or more driven sprockets, it is desirable to reduce the level of noise generated during the operation of the transmission.

Impact noise, generated as pins, bushings, or rollers of the chain contact sprocket teeth is a major factor in the generation of noise, and is also a factor causing vibrations, breakage and wear of the chain and the sprockets, impairing their durability.

To alleviate impact and impact noise it is known to utilize a sprocket having cushion rings, as shown in FIG. 9. Sprocket 500 has teeth 510, having tooth tips 511 and tooth bottoms 512 and formed around a periphery of a sprocket hub 501. Resilient cushion rings 520 are formed on both sides of the sprocket hub 501 for contact with link plates of the chain. The sprocket 500 is alleviate impact by an arrangement such that the link plates contact the outer peripheral surface 521 of the cushion ring 520 just before a pin, bushing or roller of the chain contacts a tooth 510 of the sprocket.

When the sprocket is engaged by a roller chain comprising alternating inner and outer links connected by means of connecting pins, the middle portion along the longitudinal direction of each link plate most closely approaches the center of the sprocket as the chain winds around the sprocket. Accordingly, a part of the outer peripheral surface of the cushion ring contacts the middle portion of each link plate. This middle portion of the link plate deforms the cushion ring at an angular position corresponding to the angular position of the sprocket tooth tips.

In order to adjust this resilient force and thereby control the contact of the rollers and the sprocket teeth during engagement, it is also known to use a sprocket having with grooves on the outer peripheral surface of its cushion ring with equal pitch with the teeth of the sprocket and the outer peripheral surface between the grooves of the cushion ring are inclined with respect to a circumferential surface as disclosed in the International Patent application published as Publication No. WO 00/11374 on Mar. 2, 2000 and in its counterpart, Japanese Published Patent Application No. H2002-523698.

The cushion ring of the known sprocket repeats compressive deformation caused by the contact with each link plate of the chain and released recovery caused by disengagement when the chain is suspended and rotated around the sprockets.

The parts of the cushion ring 520 which are pressed strongly by the respective link plate are located at positions that are alternately shifted in the direction of the width of the cushion ring as shown in FIG. 10A. That is, areas U1 are pressed and deformed by the inner link plates, and areas G1 are pressed and deformed by the outer link plates. These areas U1 and G1 are located at positions corresponding to the positions of the tips of the sprocket teeth. Because of the repeated alternating deformation of the cushion ring, local deterioration of the cushion ring is generated. When the cushion ring is formed of a resilient material such as rubber, the cushion ring can be torn apart, and its failure can have a serious adverse affect on the operation of the chain transmission mechanism.

The effects of deformation due to contact between the cushion ring and the link plates of the chain become even more pronounced when the sprocket has an odd number of teeth. As illustrated in FIG. 1B, as the sprocket rotates, areas U1, G1, and U1 are first pressed and deformed. Then, when the sprocket goes through a full rotation, areas G2, U2 and G2 are pressed and deformed. The alternating pattern of deformation that occurs adjacent each sprocket tooth in the case of a sprocket having an odd number of teeth, can result in a repeated twisting of the cushion ring within a very narrow space, which causes chipping of the surface of the cushion ring, deterioration of the cushion ring, and the possibility of its being torn.

Although the deterioration caused by repetitive twisting can be alleviated more or less by the grooves in the cushion ring of the International Patent application published as Publication No. WO 00/11374, it is difficult to alleviate the deterioration caused by the large deformation when the sprocket has an odd number of teeth.

### SUMMARY OF THE INVENTION

The invention addresses the aforementioned problems by providing a sprocket which is capable of reducing vibration, breakage and wear of a chain transmission and of improving durability of a chain transmission mechanism as a whole, by utilizing a cushion ring to reduce impact and impact noise caused by contact with a chain, while reducing local deterioration of the cushion ring and preventing the cushion ring from being torn.

The sprocket comprises a sprocket hub having a plurality of sprocket teeth having alternating tooth tips and tooth bottoms. The sprocket teeth are formed around a peripheral surface of the sprocket hub for engagement with pins, bushings or rollers of a transmission chain. The sprocket also comprises a cushion ring provided on at least one side of the sprocket hub, the cushion ring having an outer peripheral surface for contact with link plates of the chain.

The cushion ring comprises large radius portions and small radius portions alternating with one another around the periphery of the cushion ring, the small radius portions having a pitch equal to the pitch of said sprocket teeth. The smallest radius of each small radius portion of the cushion ring is laterally adjacent the largest radius of a tooth tip of said plurality of teeth.

The cushion ring is pressed most strongly, and is deformed, by the end portions of the link plates of the chain, which overlap one another, rather than by intermediate portions of the link plates. Thus, alternating deformation of the cushion ring at locations spaced widthwise from one another can be avoided, and impact and impact noise caused as the chain engages the sprocket can be alleviated.

Furthermore, since with the invention, deformation of the cushion ring occurs primarily by contact between the ring and overlapping end portions of the link plates of the chain, the alternating deformation that occurs in the case of a sprocket having an odd number of teeth, as illustrated in FIG. 1B, is avoided, and deterioration of the cushion ring due to chipping and tearing can be significantly reduced.

When the sprocket is used in combination with a transmission chain comprising interconnected link plates and pins, bushings or rollers, the large radius portions can be convex portions provided at angular positions corresponding to the angular positions of the tooth bottoms, and the small radius portions can be concave portions provided at angular positions corresponding to the angular positions of the tooth tips. The radii of the convex portions of the cushion ring are sufficiently large that the convex portions contact the link plates of said chain when the chain is in mesh with the sprocket teeth. The contact pressure is larger at both ends of each link plate, but the pressure is lower, or eliminated entirely, at the middle portion of each link plate. This configuration enables stress to be dispersed smoothly, by providing for resilient deformation of the cushion ring over a broad range of its outer peripheral surface, while suppressing the ability of the middle portions of the chain link plates to deform the cushion ring, and reducing local deterioration of the cushion ring. Accordingly, it is possible to alleviate impact and impact noise more effectively.

The convex portions can include convex portions having different radii, which can reduce cyclic noises and resonance caused by impact, reduce vibrations, breakage, and wear of the chain transmission mechanism as a whole, and improve its durability.

The radii of said concave portions can be sufficiently small that the concave portions are out of contact with the link plates of the chain when the chain is in mesh with the sprocket teeth. Avoidance of contact with the middle parts of the link plates can decrease tearing and other local deterioration of the cushion ring due to alternating contact between the cushion ring and the link plates of the chain at different widthwise locations.

Alternatively, the radii of the concave portions can be sufficiently small that, when the chain is in mesh with the sprocket teeth, the concave portions contact link plates of the chain, but the contact pressure at the locations at which the concave portions contact link plates of the chain is less than the contact pressure at the locations at which the convex portions contact link plates of the chain. Reduction of contact pressure between the cushion ring and the middle parts of the link plates can also decrease tearing and other local deterioration of the cushion ring due to repeated alternating contact between the cushion ring and the link plates of the chain at different widthwise locations.

The concave portions can also include concave portions having different radii, which can also vary the impact and impact noise and contribute to the reduction in cyclic noises and the resonance, reduce vibrations, breakage and wear, and improve durability.

The cushion ring can be provided with grooves, extending in the direction of the width of the sprocket, at angular positions corresponding to the angular positions of the tooth tips. With the use of these grooves it becomes possible to decrease the resilient force at the locations at which the link plates contact the cushion ring, and to decrease tearing and other local deterioration of the cushion ring due to repeated alternating contact between the cushion ring and the link plates of the chain at different widthwise locations. It is also possible to prevent the chain transmission mechanism from being seriously affected by fracture, to reduce vibrations, breakage and wear of the chain transmission mechanism as a whole, and to improve its durability. It is also possible to form the grooves easily in a circular cylindrical cushion ring.

The outer peripheral surface of the cushion ring can formed so that the radius thereof at widthwise positions corresponding to the widthwise positions of the inner link plates of the chain is different from the radius thereof at widthwise positions corresponding to the widthwise positions of the outer link plates. With this arrangement it is also possible to decrease deformation of the cushion ring and to avoid the effects of repeated alternating contact between the cushion ring and the link plates of the chain at different widthwise locations.

The part of the outer peripheral surface of the cushion ring that contacts one of sets of link plates comprising the set of inner link plates and the set of outer link plates, can have a circular cylindrical shape. With this configuration, it is also possible to resiliently deform the cushion ring over a large area while reducing the local deformation of cushion ring and to avoid the effects of repeated alternating contact at different widthwise locations on the cushion ring.

In each case, it is possible to reduce local deterioration, tearing and other damage, to prevent the chain transmission mechanism from being seriously affected by fracture, to reduce vibration, breakage and wear of the chain transmission mechanism as a whole, and to improve its durability.

### BRIEF DESCRIPTION OF DRAWINGS

FIG. 1 is a perspective view of a sprocket according to a first embodiment of the invention;

FIG. 2 is a side elevational view of the sprocket of FIG. 1, including an enlarged auxiliary view of a part of the sprocket, showing its relationship to a transmission chain;

FIG. 3 is a cross-sectional view and an enlarged auxiliary taken on section plane 3-3 in FIG. 2;

FIG. 4 is a cross-sectional view of a sprocket according to a second embodiment of the invention, including an enlarged auxiliary view of a part of the sprocket, showing its relationship to a transmission chain;

FIG. 5 is an enlarged cross-sectional showing a modification of the sprocket of the second embodiment;

FIG. 6 is an enlarged cross-sectional showing a sprocket according to a third embodiment of the invention;

FIG. 7 is an enlarged cross-sectional showing a sprocket according to a fourth embodiment of the invention;

FIG. 8 is an enlarged cross-sectional showing a modification of the sprocket of the fourth embodiment

FIG. 9 is a perspective view of a prior art sprocket; and

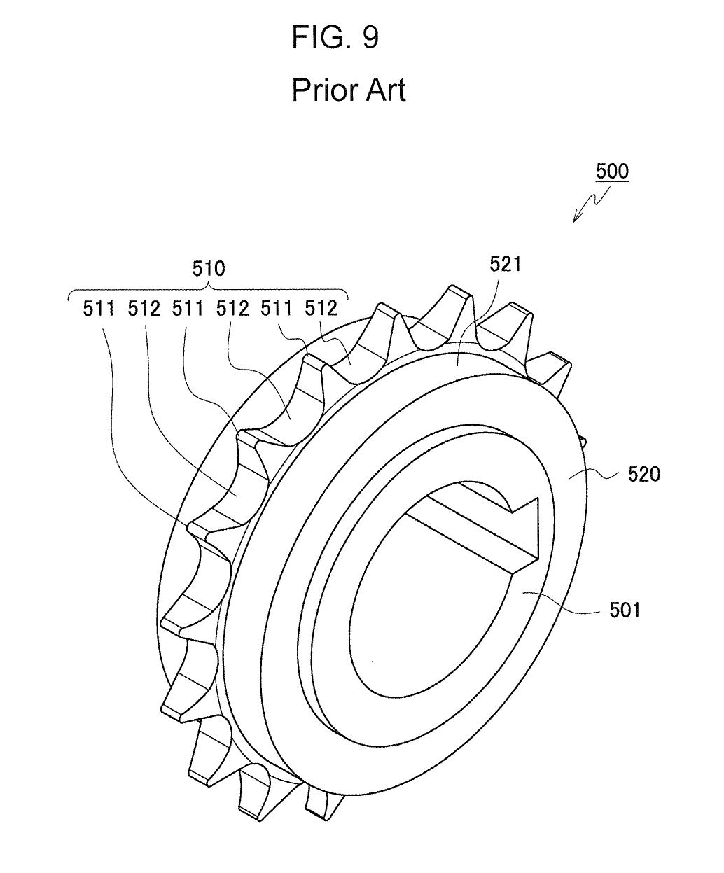

FIGS. 10A and 10B are schematic drawings illustrating the pressures applied to a cushion ring of the prior art sprocket.

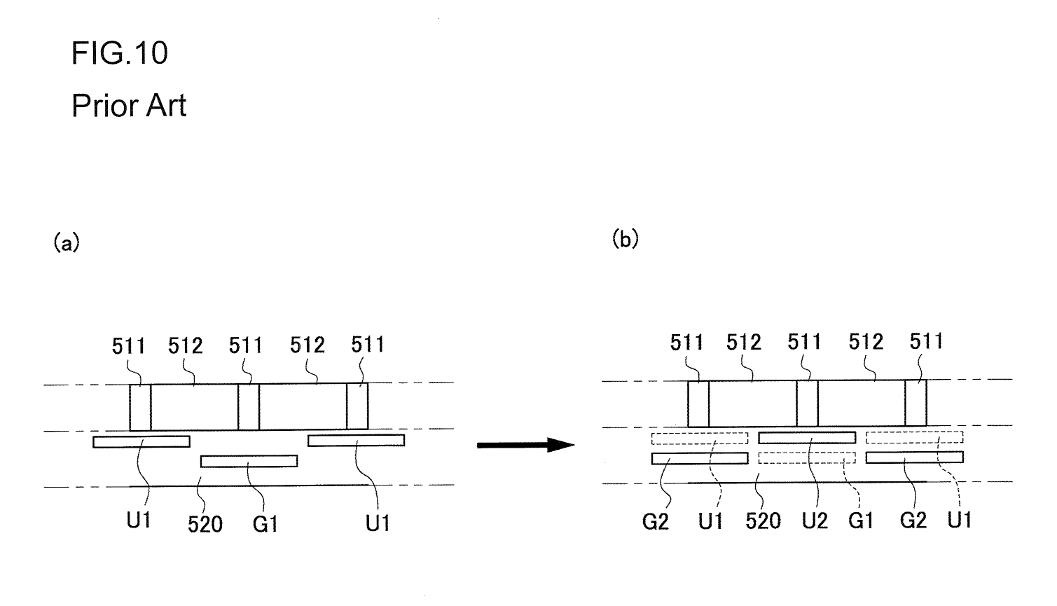

### DETAILED DESCRIPTION OF THE PREFERRED EMBODIMENTS

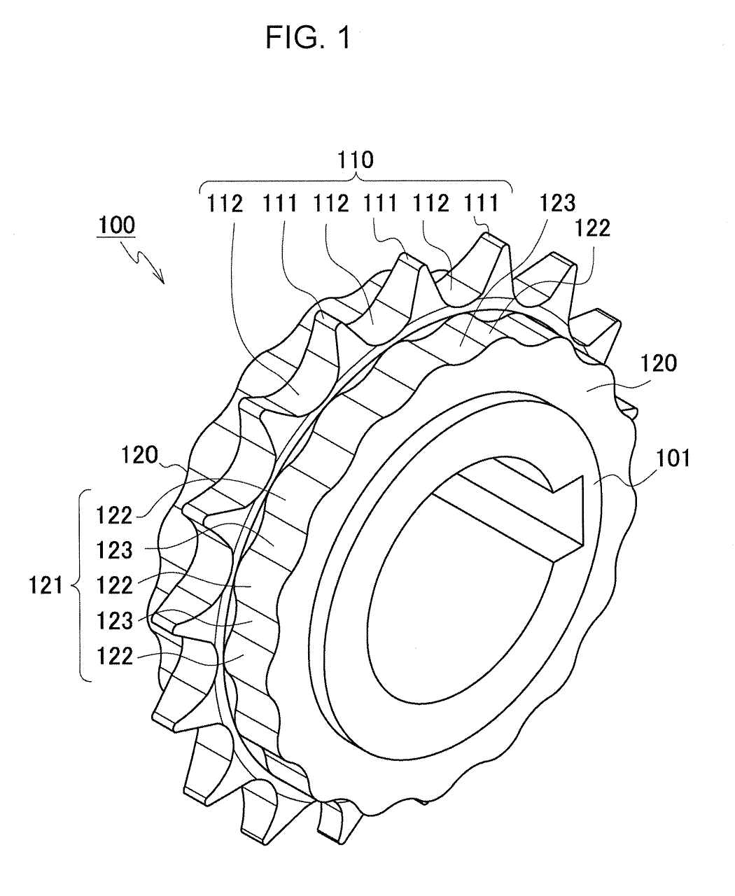

As shown in FIGS. 1 through 3, sprocket 100 is provided with teeth 110 having tooth tips 111 and tooth bottoms 112. The teeth are disposed uniformly around a sprocket hub 101. Cushion rings 120, made of a resilient material and having outer peripheral surfaces 121 for contact with link plates of a transmission chain, are provided on the both sides of the hub 101.

The cushion rings 120 are provided with convex portions 122 and concave portions 123, arranged alternately in the circumferential direction. Each cushion ring 120 is formed so that each of its convex portions 122 is located opposite a tooth bottom 112 in the direction of the width of the sprocket, and so that each of its concave portions 123 is located opposite a tooth tip 111 in the direction of the width of the sprocket. Thus, the convex portions 122 of the cushion rings occupy angular positions corresponding to those of the tooth bottoms of the sprocket teeth and the concave portions of the cushion rings occupy angular positions corresponding to those of the tooth tips of the sprocket teeth.

In this embodiment, the convex portions 122 and the concave portions 123 are smoothly continuous with one another so that the outer peripheral surfaces of the cushion rings have a wave-like profile.

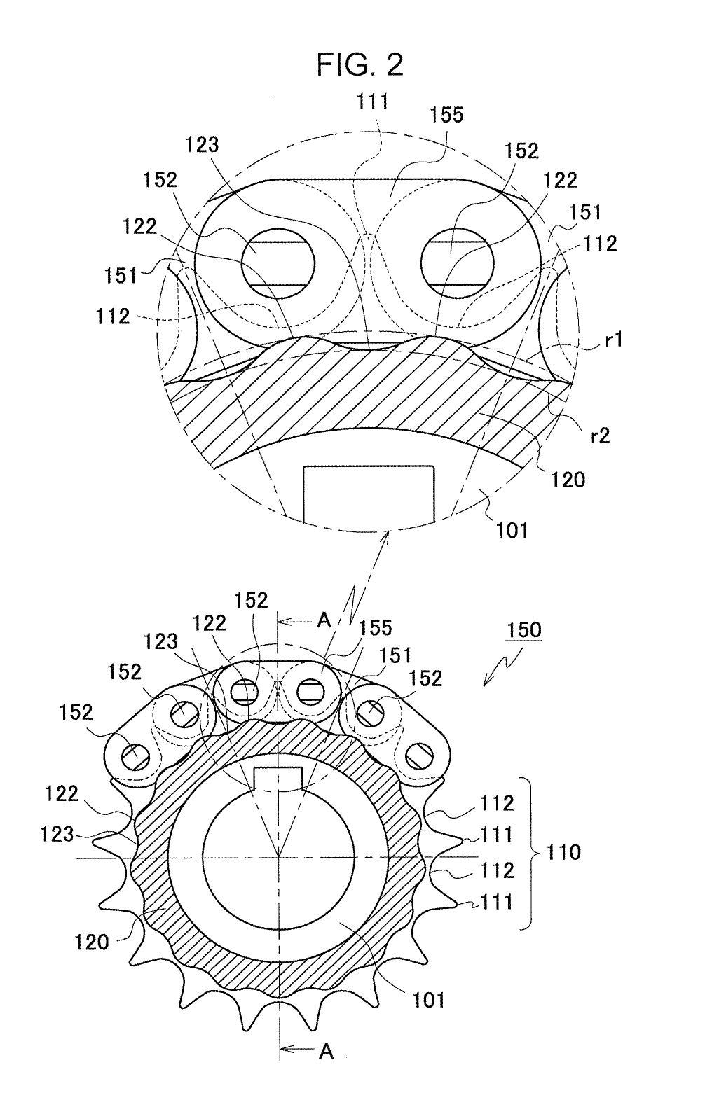

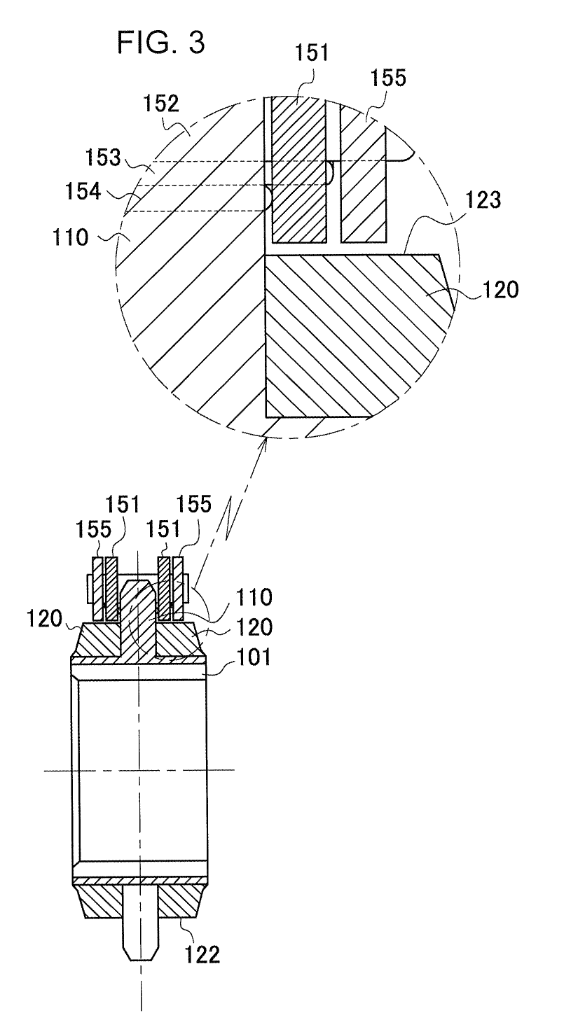

In FIGS. 2 and 3 a transmission chain 150 is in engagement with the sprocket 100. The chain 150 is a roller chain, having pairs of outer link plates 155 into which bushings 153 are fitted, pairs of inner link plates 151 into which connecting pins 152 are fitted, and rollers 154. Pairs of outer link plates 155 and pairs of inner link plates 151 are flexibly linked in alternating arrangement by fitting the connecting pins 152 rotatably into the bushings 153. The rollers 154 fit rotatably around the bushings 153.

As shown in the enlarged auxiliary view in FIG. 2, the parts of the convex portions 122 of the cushion ring 120 having the maximum radius, that is, radius r1, occupy the same angular positions as the tooth bottoms 112 of the sprocket so that they are contacted and pressed by end portions of the of the outer and inner link plates 155 and 151 of the chain 150. Similarly, the parts of the concave portions 123 having the minimum radius, that is, radius r2, occupy the same angular positions as the tooth tips. The concave portions either do not contact the middle parts of the link plates 155 and 151 of the chain, or, if they do contact the middle parts of the link plates, the contact pressure is less than the contact pressure at the locations at which the convex portions 122 contact the link plates. As a result it is possible to reduce deformation of the cushion ring.

Because the cushion ring either does not contact the middle parts of the link plates at all, or contacts the middle parts with reduced pressure, there is no repeating large deformation of the cushion ring that causes early deterioration or tearing of the cushion ring, even in the case of a sprocket having an odd number of teeth.

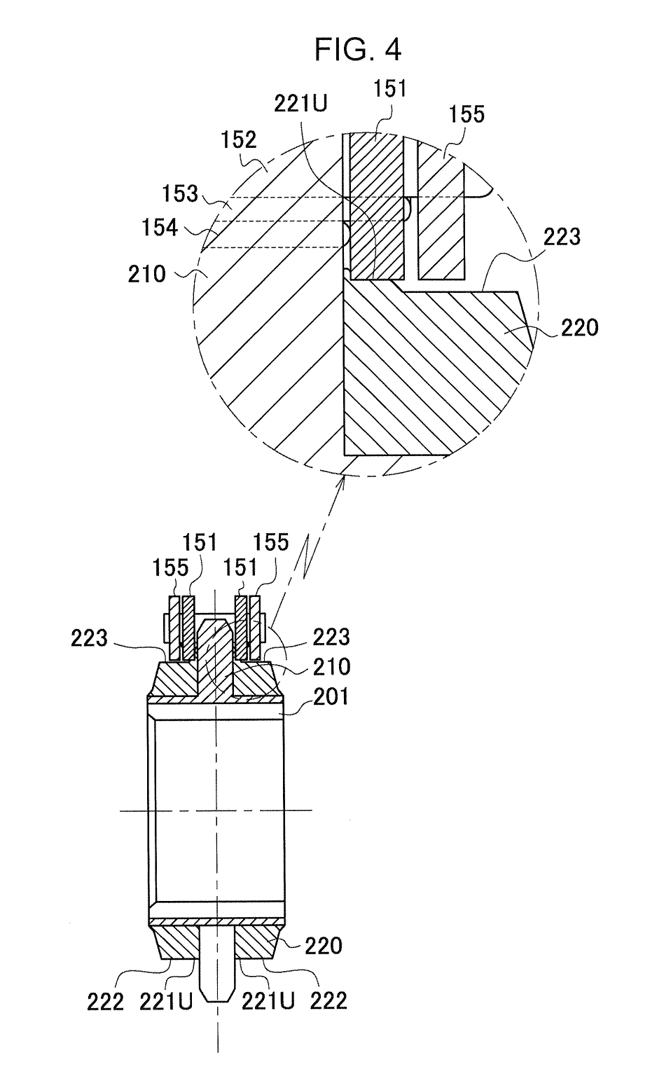

The structure of a sprocket of the second embodiment is the same with that of the sprocket of the first embodiment except for the cushion ring. As shown in FIG. 4, the cushion ring 220 of sprocket 200 is formed so that the part of the cushion ring that contacts the inner link plates 151 of the chain has a circular cylindrical surface 221U that contacts and presses the middle part of the inner link plates 151 in the same manner that the prior art cushion ring contacts and presses the link plates of a chain. On the other hand, the part of the outer peripheral surface of the cushion ring that contacts the outer link plates 155 has a configuration similar to that of the cushion ring of the first embodiment. That is, convex portions and concave portions 223 alternate in the circumferential direction, the concave portions are formed at angular positions corresponding to the angular positions of the sprocket tooth tips, and the convex portions are formed at angular positions corresponding to the angular positions of the tooth bottoms.

In this second embodiment, the middle parts of the inner link plates 151 contact and presses the circular cylindrical surface 221U, alleviating impact noise. However, because the middle parts of the outer link plates 155 do not contact the cushion ring, or contact the cushion ring with reduced pressure, there is no repeating large deformation of the cushion ring, even in the case of a sprocket having an odd number of teeth.

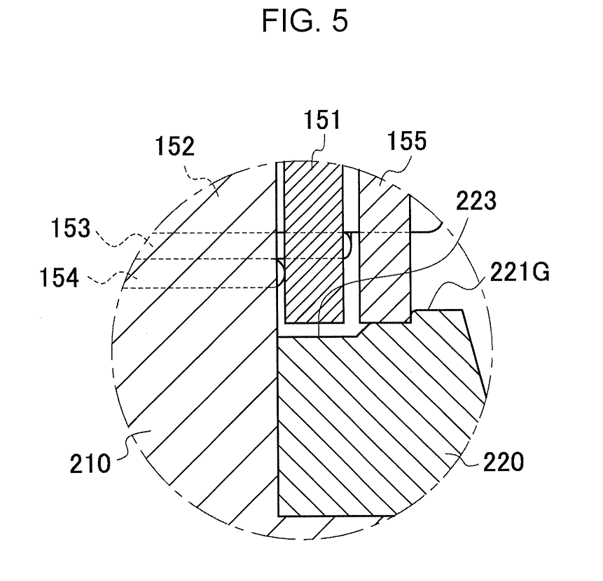

In a modified version of the second embodiment, as shown in FIG. 5, the part of the surface 221G that contacts the outer link plates 155 is in the form of a circular cylinder while the part that contacts the inner link plates 151 has alternating convex and concave portions, the angular positions of the concave portions corresponding to the angular positions of the tooth tips and the angular positions of the convex portions corresponding to the angular positions of the tooth bottoms.

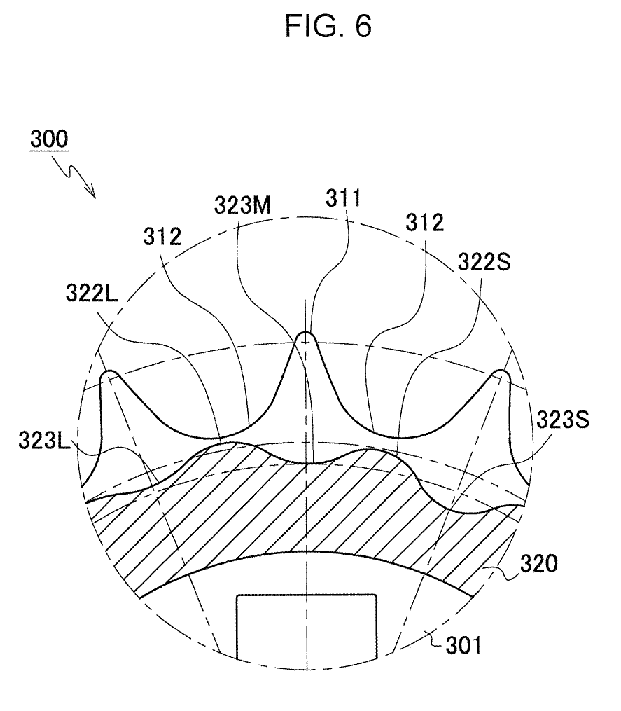

The structure of a sprocket 300 of the third embodiment is the same with that of the first or second embodiment, except that the radii of the convex and concave portions of the cushion ring are different as shown in FIG. 6.

In cushion ring 320, convex portions 322L and 322S have different maximum radii, and concave portions 323L, 323M and 323S also have different minimum radii. By varying the radii of the convex and concave portions of the cushion ring, it becomes possible to vary the impact noise and thereby suppress cyclic noise and resonance. The sequence of the various kinds of convex and concave portions proceeding in the circumferential direction of the cushion ring can be varied.

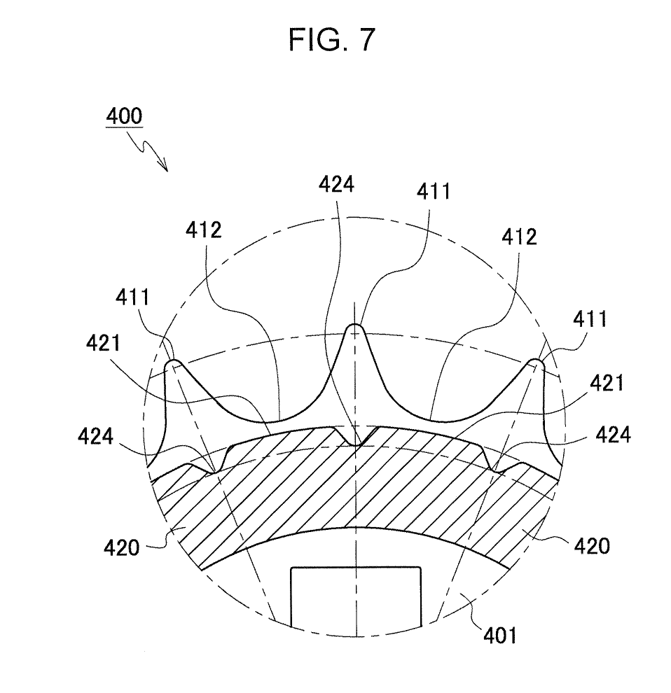

The structure of a sprocket 400 of the fourth embodiment is the same as that of the first and second embodiments, except for the cushion ring. As shown in FIG. 7, the cushion ring 420 of a sprocket 400 is provided with grooves 424 that extend in the direction of the width of the sprocket at angular positions corresponding to the angular positions of the tooth tips 411. Except for the grooves, the outer peripheral surface 421 has a circular cylindrical shape corresponding to that of the cushion ring of the prior art.

The configuration of the cushion ring in the fourth embodiment allows the parts of the cushion ring on both sides of each groove to deform readily, and reduces the contact force at the location at which the middle portions of the link plates contact the cushion ring, dispersing stress. Accordingly, it becomes possible to reduce local deterioration and tearing of the cushion ring. It is also possible to manufacture the cushion ring of the fourth embodiment easily by forming grooves in the cylindrical surface of the prior art cushion ring.

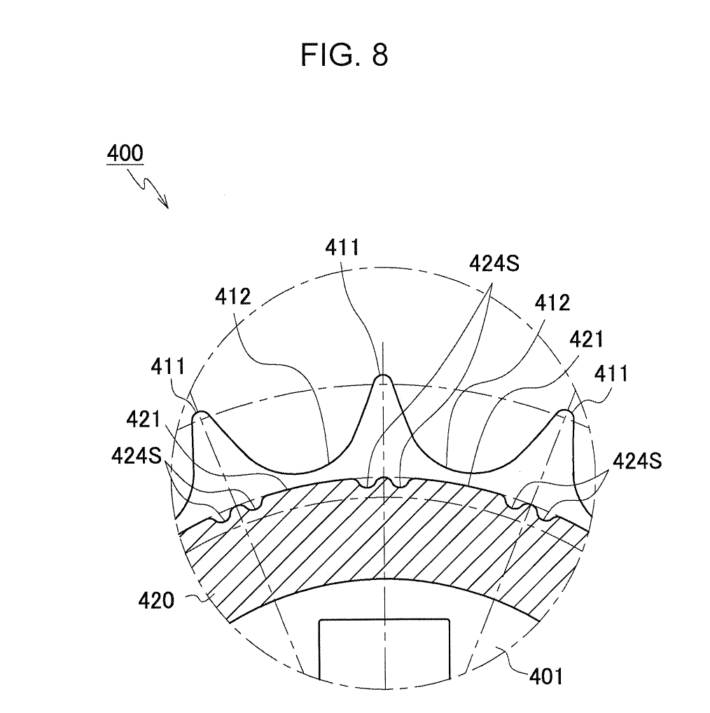

In a modification of the fourth embodiment, instead of providing a single groove in a cushion ring at an angular position corresponding to the angular position of each sprocket tooth tip, plural adjacent grooves 424S may be provided in groups as shown in FIG. 8.

The grooves in the fourth embodiment and in the modified versions thereof have any of various widths, depths and sectional profiles.

The sprocket of the invention can alleviate impact noise caused when a transmission chain comes into engagement with a sprocket. It can also reduce local deterioration of the cushion ring, prevent damage such as tearing from occurring, reduce vibration, breakage and wear of the chain transmission and improve its durability.

The sprocket can be used with various kinds of roller chains, rollerless bushing chains and the like.

The hub and teeth of the sprocket can be composed of any of various materials such as metal, e.g., steel, ceramics, and resins, and may be composed of composite materials. The material of the cushion ring can be any suitable material such as rubber, or synthetic resin, as long as it exhibits resilience so that it is capable of reducing the sound generated by contact with a chain.

What is claimed is:

1. A sprocket comprising a sprocket hub having a plurality of sprocket teeth having alternating tooth tips and tooth bottoms, said sprocket teeth being formed around a peripheral surface of the sprocket hub for engagement with pins, bushings or rollers of a transmission chain, and a cushion ring provided on at least one side of the sprocket hub, the cushion ring having an outer peripheral surface for contact with link plates of said chain;
wherein said cushion ring comprises large radius portions and small radius portions alternating with one another around the periphery of the cushion ring, the small radius portions having a pitch equal to the pitch of said sprocket teeth; and
wherein the smallest radius of each small radius portion of the cushion ring is laterally adjacent the largest radius of a tooth tip of said plurality of teeth.

2. The sprocket according to claim 1 in combination with a transmission chain comprising interconnected link plates and pins, bushings or rollers, and wherein large radius portions are convex portions provided at angular positions corresponding to the angular positions of said tooth bottoms and said small radius portions are concave portions provided at angular positions corresponding to the angular positions of the tooth tips, and wherein the radii of the convex portions of said cushion ring are sufficiently large that the convex portions contact the link plates of said chain when the chain is in mesh with the sprocket teeth.

3. The sprocket according to claim 2, wherein said convex portions include convex portions having different radii.

4. The sprocket according to claim 2, wherein the radii of said concave portions is sufficiently small that the concave portions are out of contact with the link plates of the chain when the chain is in mesh with the sprocket teeth.

5. The sprocket according to claim 2, wherein the radii of said concave portions is sufficiently small that, when the chain is in mesh with the sprocket teeth, the concave portions contact link plates of the chain, but the contact pressure at the locations at which the concave portions contact link plates of the chain is less than the contact pressure at the locations at which the convex portions contact link plates of the chain.

6. The sprocket according to claim 2, wherein said concave portions include concave portions having different radii.

7. The sprocket according to claim 3, wherein said concave portions include concave portions having different radii.

8. The sprocket according to claim 4, wherein said concave portions include concave portions having different radii.

9. The sprocket according to claim 5, wherein said concave portions include concave portions having different radii.

10. The sprocket according to claim 1, wherein said cushion ring is provided with grooves, extending in the direction of the width of the sprocket, at angular positions corresponding to the angular positions of the tooth tips.

11. The sprocket according to claim 1, wherein the outer peripheral surface of the cushion ring is formed so that the radius thereof at widthwise positions corresponding to the widthwise positions of the inner link plates of the chain is different from the radius thereof at widthwise positions corresponding to the widthwise positions of the outer link plates.

12. The sprocket according to claim 11, wherein the part of the outer peripheral surface of said cushion ring that contacts one of sets of link plates comprising the set of inner link plates and the set of outer link plates, has a circular cylindrical shape.
